(19) United States
(12) Patent Application Publication
(10) Pub. No.: US 2025/0220704 A1
(43) Pub. Date: Jul. 3, 2025

(54) SELECTIVE RESPECT FOR OVERLAPPING BASIC SERVICE SET COORDINATED RESTRICTED TARGET WAKE TIME SCHEDULES

(71) Applicant: Cisco Technology, Inc., San Jose, CA (US)

(72) Inventor: Brian D. Hart, Sunnyvale, CA (US)

(73) Assignee: Cisco Technology, Inc., San Jose, CA (US)

(21) Appl. No.: 18/786,221

(22) Filed: Jul. 26, 2024

Related U.S. Application Data
(60) Provisional application No. 63/616,547, filed on Dec. 30, 2023.

(51) Int. Cl. H04W 74/04

(52) U.S. Cl. CPC H04W 74/04

(57) ABSTRACT

Coordinated Restricted Target Wait Time (rTWT) scheduling may be provided. Coordinated rTWT scheduling can be performed with an Overlapping Basic Service Set (OBSS), including determining one or more service periods for the OBSS. A coordinated rTWT service period frame is generated comprising one or more service period elements each associated with one of the one or more service periods for the OBSS. The coordinated rTWT service period frame is sent to a Station (STA), wherein the STA is operable to determine whether to communicate during the one or more service periods of the OBSS based on the one or more service period elements.

### RELATED APPLICATION

Under provisions of 35 U.S.C. § 119(e), Applicant claims the benefit of and priority to U.S. Provisional Application No. 63/616,547, filed Dec. 30, 2023, the disclosure of which is incorporated herein by reference in its entirety.

### TECHNICAL FIELD

The present disclosure relates generally to providing coordinated Restricted Target Wait Time (rTWT) scheduling.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for coordinated Restricted Target Wait Time (rTWT) scheduling in accordance with aspects of the present disclosure.

FIG. 2 is a block diagram of a coordinated rTWT service period frame in accordance with aspects of the present disclosure.

FIG. 3 is a flowchart of a method 400 for STAs to respect coordinated rTWT scheduling in accordance with aspects of the present disclosure.

FIG. 4 is a block diagram of a divided BSS for coordinated rTWT scheduling in accordance with aspects of the present disclosure.

FIG. 5 is a flowchart of a method for coordinated rTWT scheduling in accordance with aspects of the present disclosure.

FIG. 6 is a block diagram of a computing device in accordance with aspects of the present disclosure.

FIG. 7 is a block diagram of a wireless device in accordance with aspects of the present disclosure.

### DETAILED DESCRIPTION

### Overview

Coordinated Restricted Target Wait Time (rTWT) scheduling may be provided. Coordinated rTWT scheduling can be performed with an Overlapping Basic Service Set (OBSS), including determining one or more service periods for the OBSS. A coordinated rTWT service period frame is generated comprising one or more service period elements each associated with one of the one or more service periods for the OBSS. The coordinated rTWT service period frame is sent to a Station (STA), wherein the STA is operable to determine whether to communicate during the one or more service periods of the OBSS based on the one or more service period elements.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Multi-Access Point (AP) Coordination (MAPC) can be implemented to attempt to mitigate interference between Overlapping Basic Service Set (OBSS) APs. For example, coordinated Restricted Target Wait Time (rTWT) can be implemented to mitigate said interference. rTWT establishes periods for devices in a Basic Service Set (BSS) to wake up and send and/or receive data. Using rTWT allows devices in the BSS, such as APs and clients, to avoid transmitting (e.g., Physical Layer Protocol Data Units (PPDU)) beyond a period specified by a rTWT. Coordinated rTWT includes the OBSS APs to coordinate the rTWT periods to mitigate interference between devices in the OBSSs (e.g., preventing a client in one BSS from interfering with a client in another OBSS). Thus, coordinated rTWT includes scheduling a regular sequence of service periods for client(s) that should be respected by other devices, including same BSS APs and clients and OBSS APs and clients. APs can implement coordinated rTWT to address interference for devices in the same BSS and in OBSSs, reducing collisions, enabling timely delivery of traffic, and the like.

Because there may be many devices in the same BSS and in OBSSs and not every device may cause interference on another device in an OBSS, announcing scheduling information for each device can lead to overprotection of devices. For example, when a device in an OBSS would not interfere with a device being assigned a rTWT service period, restricting that device from communicating during the rTWT service period unnecessarily leads to worse network performance for the device since it could communicate without introducing interference. Additionally, the signals or beacons that are used to announce scheduling information consume airtime and reduce the capacity of the network. Announcing all scheduling information for devices in OBSS can thus degrade network performance by consuming a significant portion of airtime and reducing capacity. Therefore, devices in OBSSs may need to determine when devices should respect coordinated rTWT periods and use efficient signaling to indicate the rTWT periods.

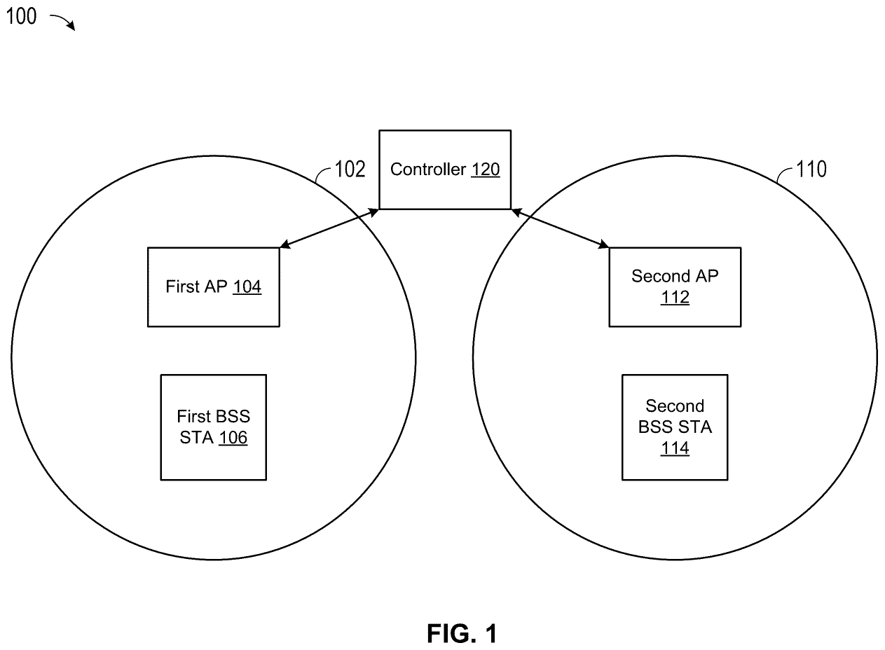

FIG. 1 is a block diagram of an operating environment 100 for coordinated rTWT scheduling. The operating environment 100 includes a first BSS 102 comprising a first AP 104 and a first BSS STA 106. The operating environment 100 also includes a second BSS 110 comprising a second AP 112 and a second BSS STA 114. The first AP 104 and the second AP 112 can enable clients to connect to the network and communicate with other devices connected to the network. The first BSS STA 106 and the second BSS STA 114 can be any device that connects to the network to communicate with other devices on the network, such as a smart phone, a tablet, a personal computer, a server, and/or the like. The first BSS 102 can include any number of first BSS STAs 106 that connect to the network via the first AP 104. Similarly, the second BSS 110 can include any number of second BSS STAs 114 that connect to the network via the second AP 112.

The operating environment 100 can also include a controller 120. The controller 120 may manage the first AP 104, the second AP 112, and/or other devices of the network. The controller 120 for example can manage the operation of the APs, manage the traffic of the APs (e.g., including traffic of the first BSS STA 106 and the second BSS STA 114), and so on.

The first BSS 102 and the second BSS 110 may be physically positioned so they are OBSSs. Thus, the first AP 104, the controller 120, and/or the like considers the second BSS 110 as an OBSS of the first BSS 102, and the second AP 112, the controller 120, and/or the like considers the first BSS 102 as an OBSS of the second BSS 110.

Because the first BSS 102 and the second BSS 110 are OBSSs, the first BSS 102 and the second BSS 110 may perform coordinated rTWT scheduling to avoid interference between the OBSSs. For example, the coordinated rTWT scheduling can enable the first BSS STA 106 to respect rTWT service periods of the second BSS STA 114, and the second BSS STA 114 can respect the rTWT service periods of the first BSS STA 16 to avoid interfering during the service periods. However, the first BSS STA 106 and the second BSS STA 114 may be positioned so the STAs will not interfere if they transmit and/or receive during a service period of the other STA. Thus, the first AP 104, the second AP 112, and/or the controller 120 may provide signals to the first BSS STA 106 and the second BSS STA 114 to indicate when the STAs must respect the rTWT service period of another STA or when the STAs must respect the rTWT service period of another STA only if activity is heard by the STAs. For example, during a rTWT service period for the first BSS STA 106, the second BSS STA 114 may communicate during the service period unless the second BSS STA 114 determines the communications of the first BSS STA 106 can be heard or are otherwise in range of the second BSS STA 114. A rTWT service period can be determined to always be respected when the expected priority of the traffic is high (e.g., above a threshold). A rTWT service period can be determined to be respected if activity is heard when the expected priority of the traffic is low (e.g., below the threshold).

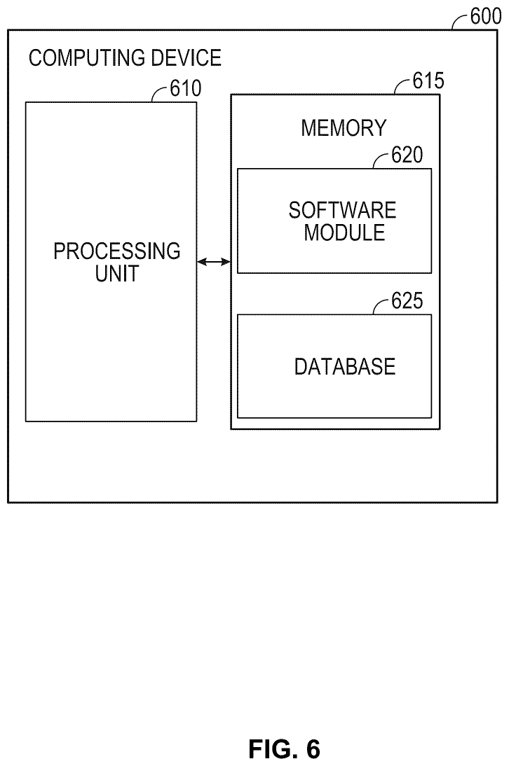

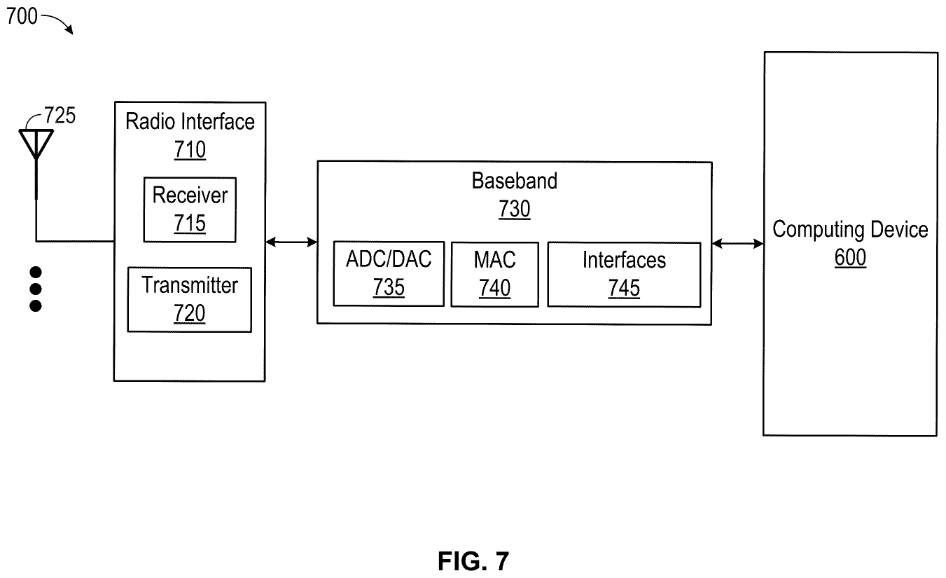

The elements described above of the operating environment 100 (e.g., the first AP 104, the first BSS STA 106, the second AP 112, the second BSS STA 114, the controller 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

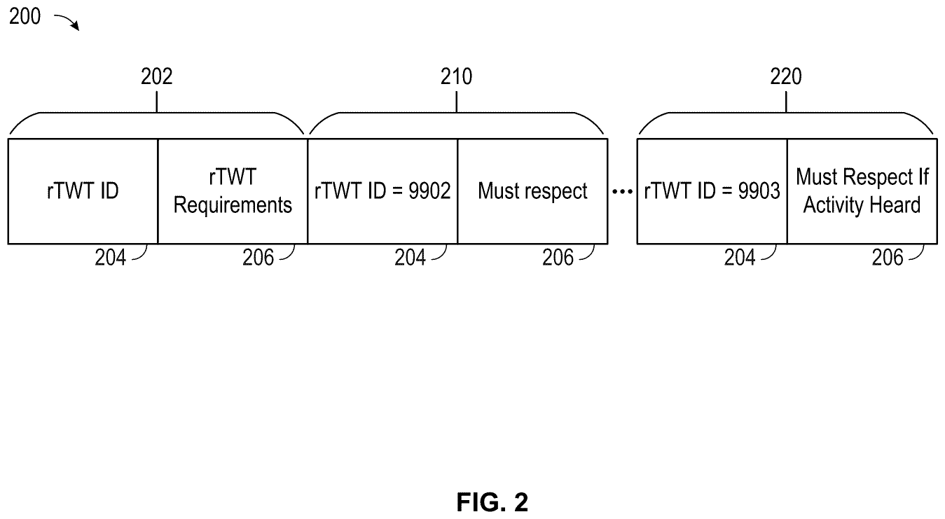

FIG. 2 is a block diagram of a coordinated rTWT service period frame 200. The first AP 104, the second AP 112, and/or the controller 120 can generate coordinated rTWT service period frames 200 to indicate the service period schedule of OBSSs. For example, the OBSSs may be participating in coordinated rTWT service period scheduling. The coordinated rTWT service period frame 200 can indicate whether service periods must always be respected or respected only if a device hears activity, and/or the like. The first AP 104 and the second AP 112 can share with their respective STAs the generated coordinated rTWT service period frames 200 or information included in the coordinated rTWT service period frames 200 for the STAs to determine whether the service periods must always be respected or whether the service period must be respected when activity is heard.

The first AP 104, the second AP 112, and/or the controller 120 can determine the service periods for coordinated rTWT before generating the coordinated rTWT service period frames 200. Thus, the first AP 104 and the second AP 112 can identify the scheduled service periods of the respective BSSs and generate the coordinated rTWT service period frame 200. In some embodiments, the BSS AP updates the respective coordinated rTWT service period frame 200 of its BSS as the OBSSs continue to schedule service periods.

The coordinated rTWT service period frame 200 includes a first service period element 202 comprising a rTWT ID field 204 and a rTWT requirements field 206. The rTWT ID field 204 can identify the rTWT service period (e.g., as scheduled before the generation of coordinated rTWT service period frames 200). In some embodiments, the rTWT ID field 204 also indicates the details of the associated rTWT service period, such as the start time, duration, and/or the like. The rTWT requirements field 206 indicates communication requirements of the associated service period. In certain embodiments for example, the rTWT requirements field 206 indicates (i) the associated rTWT service period must always be respected or (ii) the rTWT service period must be respected if activity is heard. In some embodiments service period elements, such as the first service period element 202 can also include device information such as the BSS Identifier (BSSID), Media Access Control (MAC) addresses, and/or the like of STAs assigned or otherwise associated with the rTWT service periods. In other embodiments, the device information is available when a device requests the device information. For example, the second AP 112 may generate a coordinated rTWT service period frame 200 for service periods of the first BSS 102, and the second BSS STA 114 may request device information (e.g., using Access Network Query Protocol (ANQP)). The second AP 112 can then send the requested device information to the second BSS STA 114 in response to the request.

The coordinated rTWT service period frame 200 can include any number of service period elements, such as the second service period element 210 and the third service period element 220. The second service period element 210 includes a rTWT ID field 204 with a value of “9902” indicating the associated service period. rTWT IDs may be determined when the first AP 104, the second AP 112, and/or the controller 120 determine the coordinated rTWT service period schedule, so a device referencing the rTWT ID field 204 can associate the field's value with a scheduled service period. The second service period element 210 further includes a rTWT requirements field 206 indicating the associated service period must be respected whether STAs hear activity or not. The third service period element 220 includes a rTWT ID field 204 with a value of 49903° indicating the associated service period. The third service period element 220 further includes a rTWT requirements field 206 indicating the associated service period must be respected if activity is heard. The rTWT ID fields 204 and the rTWT requirements field 206 can indicate information as a sequence of bits in some embodiments. For example, the rTWT requirements fields 206 can have a bit set to zero if the rTWT service period must be respected only if activity is heard and set to one if the rTWT service period must always be respected.

In some embodiments, the service period elements can be associated with a sequence of service elements. Thus, the rTWT ID field 204 can include an ID for the sequence of service periods and/or IDs for the service periods. The rTWT requirements field 206 can include a requirement, such as to always respect or to respect when activity is heard, for the entire sequence of service elements or different requirements for the service periods.

The first AP 104 can generate and send a coordinated rTWT service period frame 200 including service period elements for the scheduled service periods of the first BSS 102 to any OBSSs (e.g., the second BSS 110, including to the second AP 112 and/or the second BSS STA 114). Similarly, the second AP 112 can send can generate send a coordinated rTWT service period frame 200 including service period elements for the scheduled service periods of the second BSS 110 to any OBSSs (e.g., the first BSS 102, including to the first AP 104 and/or the first BSS STA 106). The first AP 104 and the second AP 112 can send one or more beacons to transmit a coordinated rTWT service period frame 200. The coordinated rTWT service period frame 200 may include service period elements for a predefined period (e.g., for the next five minutes, for the next ten minutes, etc.). The first AP 104 and the second AP 112 can generate and send additional coordinated rTWT service period frames 200 for subsequent periods.

As described above, when a BSS generates a coordinated rTWT service period frame 200, the STAs in the BSS must not communicate during service periods associated with service period elements that indicate the service period must be respected in the rTWT requirements field 206. For example, the STAs in the OBSS must end their Transmit Opportunities (TXOPs) or otherwise stop communicating before the start of the service periods that must be respected. For example, the second service period element 210 may be associated with a service period of the first BSS STA 106, and the second BSS STA 114 must end its TXOPs before that service period.

For service periods associated with service period elements that indicate the service period must be respected only if activity is heard in the rTWT requirements field 206, OBSS STAs may initially respect the service period by ending TXOPs or otherwise stop communicating before the start of the service periods in certain embodiments. For example, the third service period element 220 may be associated with a service period of the first BSS STA 106, and the second BSS STA 114 may end its TXOPs before that service period. The OBSS STAs may then resume communications as long as activity of the assigned STA is not heard. In other embodiments, the OBSS STAs may continue communicating until activity of the assigned STA is heard.

An STA may determine whether activity of the STA assigned a service period is heard when the STA detects signals from the respective STA that have a Received Signal Strength Indicator (RSSI) above a threshold. If the STA detects multiple transmissions from different STAs (e.g., identified based on different MAC addresses) with at least a portion of the transmissions above the RSSI threshold, the AP can use the coordinated rTWT service period frame 200 to identify the STA ID (e.g., BSSID, MAC address) of the STA associated with the service period when the coordinated rTWT service period frame 200 includes the STA ID. In other embodiments, the STA can request (e.g., ANQP query) the STA ID from the APs and/or the controller 120 to obtain the “owners” (BSSID(s) and MAC address(es)) of STA associated with the service period.

The STA can then use the STA ID to determine if any of the detected signals are sent to or from the STA associated with the service period and whether those signals are above the RSSI threshold. If there are signals above the RSSI threshold and sent to or from the STA associated with the service period, the STA does not transmit during the respective service period. The STA can continue to monitor activity to determine whether the STA associated with the service period stops communicating or the communications drop below the RSSI threshold to determine to resume communicating during the respective service period. If there are no signals above the RSSI threshold and sent to or from the STA associated with the service period, then the STA can freely contend and transmit during the service period.

In some embodiments, when an OBSS STA determines the STA associated with the service period has signals sent to or from the associated STA above the RSSI threshold, the OBSS STA does not transmit during a number of subsequent service periods for the STA associated with the current service period. For example, if the second BSS STA 114 determines the first BSS STA 106 has signals sent to or from the first BSS STA 106 above the RSSI threshold during a service period assigned to the first BSS STA 106, the second AP 112 and/or the second BSS STA 114 may determine the second BSS STA 114 will not communicate during a next amount of service periods (e.g., the next four service periods, the next eight service periods) of the first BSS 102 or, specifically, subsequent service periods assigned to the first BSS STA 106. Thus, for at least a subsequent number of service periods for that OBSS or, specifically, subsequent service periods assigned to the same STA, an OBSS STA may not need to continue monitoring for signals and assume the OBSS STA should not transmit during service periods of an STA the OBSS STA has identified as positioned so the signals associated with the STA are heard above the RSSI threshold. The number of service periods can be a fixed number or a follow a constrained backoff calculation.

When an OBSS STA determines the signals associated with an STA assigned a service period are not above the RSSI threshold, the OBSS STA can determine that the OBSS STA can communicate for a number of subsequent service periods associated with the STA assigned the current service period. For example, if the second BSS STA 114 determines the first BSS STA 106 has no signals sent to or from the first BSS STA 106 above the RSSI threshold during a service period assigned to the first BSS STA 106, the second AP 112 and/or the second BSS STA 114 may determine to communicate during a next amount of service periods (e.g., the next four service periods, the next eight service periods) of the first BSS 102 or, specifically, service periods assigned to the first BSS STA 106. The number of service periods can be a fixed number or a follow a variable calculation. For example, when there is an unused service period or no signals above the RSSI threshold during the service period, the OBSS STA determines to communicate during the next two service periods. If the next service period is also unused or has no signals above the RSSI threshold, the STA can communicate during the next four service periods, and so on.

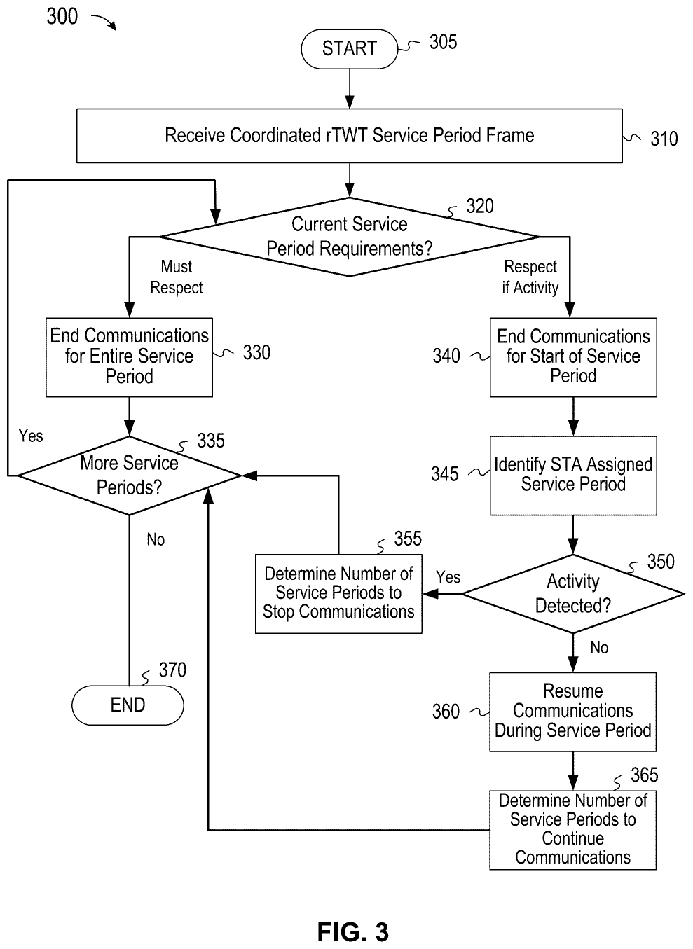

FIG. 3 is a flowchart of a method 300 for STAs to respect coordinated rTWT scheduling. STAs can implement the method 300 to determine whether to communicate during a service period of an OBSS STA. For example, the second BSS STA 114 can use the method 300 to determine whether to communicate during service periods assigned to the first BSS STA 106, and the first BSS STA 106 can use the method 300 to determine whether to communicate during service periods assigned to the second BSS STA 114.

The method 300 can begin at starting block 305 and proceed to operation 310. In operation 310, a coordinated rTWT service period frame 200 is received. For example, the first BSS STA 106 generates the coordinated rTWT service period frame 200 and sends the coordinated rTWT service period frame 200 to the first BSS STA 106.

In decision 320, the current service period requirements are determined. For example, the first BSS STA 106 determines the current service period requirements as indicated by the rTWT requirements field 206 of the associated service period element. If the current service period requirements are that the service period must be respected, the method 300 proceeds to operation 330. In operation 330, communications are ended for the entire service period. For example, the first BSS STA 106 ends communications for the entire service period.

In decision 335, it is determined whether there are more service periods scheduled. If yes, the method proceeds back to decision 320. If the current service period requirements are that the service period must be respected only if activity is heard, the method 300 proceeds to operation 340. In operation 340, communications are ended for the start of the service period. Operation 340 may be optional, for example when the first BSS STA 106 has already determined to communicate during a number of service periods assigned to the second BSS STA 114 in response to not detecting any signals above a RSSI threshold during a previous service period assigned to the second BSS STA 114.

In operation 345, the STA assigned the service period is identified. For example, the first BSS STA 106 determines the second BSS STA 114 is assigned the service period based on the coordinated rTWT service period frame 200 or by requesting device information (e.g., using ANQP).

In decision 350, it is determined whether activity is detected. For example, the first BSS STA 106 determines whether there are any detected signals sent to or from the second BSS STA 114 above the RSSI threshold. If there is activity detected, the method proceeds to operation 355. In operation 355, a number of subsequent service periods assigned to the same STA are determined to stop communication during. For example, the first AP 104 and/or the first BSS STA 106 determines the first BSS STA 106 will stop communicating for zero or more subsequent service periods assigned to the second BSS 110 or, specifically, assigned to the second BSS STA 114. The method 300 then proceeds to decision 335 for identifying if there are additional service periods.

If activity is not detected in decision 350, the method 300 proceeds to operation 360. In operation 360 communications are resumed during the service period. For example, the first BSS STA 106 determines to resume communications during the service period assigned to the second BSS STA 114. In operation 365, a number of subsequent service periods assigned to the same STA are determined to continue communication during. For example, the first AP 104 and/or the first BSS STA 106 determines the first BSS STA 106 will continue communicating for zero or more subsequent service periods assigned to the second BSS 110 or, specifically, the second BSS STA 114. The method 300 then proceeds to decision 335 for identifying if there are additional service periods. If it is determined that there are no service periods remaining during the decision 335, the method 300 can proceed to the ending block 370.

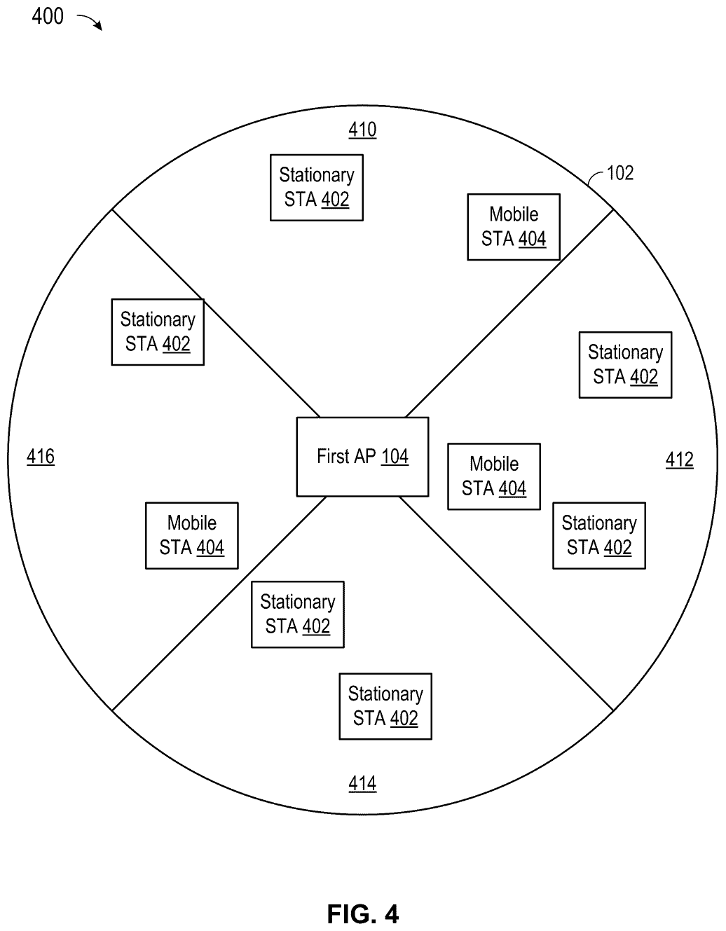

FIG. 4 is a block diagram of a divided BSS 400 for coordinated rTWT scheduling. In certain embodiments, the AP associated with the divided BSS 400 may determine quadrants to report the current service period requirements (e.g., must respect, respect if activity heard) per quadrant. In the illustrated example, the divided BSS 400 is the first BSS 102, so the first AP 104 may determine the quadrants. The divided BSS 400 includes stationary STAs 402 and mobile STAs 404. The stationary STAs 402 may be STAs whose position will remain the same at least for a period. Thus, the stationary STAs 402 may not be permanently stationary, but the first AP 104 may be able to the determine the position of the stationary STAs 402 at least during a period. The mobile STAs 404 may be STAs whose position will not necessarily remain the same at least for a period, such as a mobile phone. The stationary STAs 402 and the mobile STAs 404 may all be first BSS STAs like the first BSS STA 106 since the STAs are in the first BSS 102.

The divided BSS 400 includes a north quadrant 410, an east quadrant 412, a south quadrant 414, and a west quadrant 416. The divided BSS 400 may be apportioned differently in other examples. For example, the quadrants may be determined based on the physical positions of OBSSs. The first AP 104 may determine the number of quadrants and the area of each quadrant, including the north quadrant 410, the east quadrant 412, the south quadrant 414, and the west quadrant 416. In some embodiments, the quadrants are defined by the positions of the STAs in the divided BSS 400.

The first AP 104 may report the current service period requirements to north quadrant 410, the east quadrant 412, the south quadrant 414, and the west quadrant 416 according to how strongly STAs in the quadrant hear the OBSS AP and/or the assigned STA. For example, the first AP 104 may determine how strongly STAs in the quadrants hear the OBSS AP and/or the assigned AP via beacon reports, frame reports, or the like (e.g., 802.11k beacon reports, 802.11k frame reports. Thus, the first AP 104 may determine the stationary STAs 402 in the north quadrant 410 and the east quadrant 412 will always hear the second AP 112 and the second BSS STA 114 and supply a service period requirement of always respecting service periods assigned to the second BSS STA 114. Similarly, the first AP 104 may determine the stationary STAs 402 in the south quadrant 414 and the west quadrant 416 will not always hear the second AP 112 and the second BSS STA 114 and supply a service period requirement of only respecting service periods assigned to the second BSS STA 114 if activity is heard. The AP of a BSS can therefore selectively control service period requirements based on the OBSS scheduling service periods.

The AP of a BSS can include the requirements for each quadrant in the same coordinated rTWT service period frame 200, such as indicating each quadrant's communication requirement in the rTWT requirements field 206. In other embodiments, the AP of a BSS can generate a new coordinated rTWT service period frame 200 for each quadrant.

The mobile STAs 404 may not be assigned a quadrant since the first AP 104 cannot definitively determine what the position of the mobile STAs 404 will be during an upcoming service period. Thus, the first AP 104 may assign the most conservative service period requirement to all of the mobile STAs 404. For example, when one or more quadrants have to always respect the service period, the mobile STAs 404 will also have to always respect the service period. When the most conservative requirement is only having to respect the service period when activity is detected, the mobile STAs 404 will be assigned the same requirement.

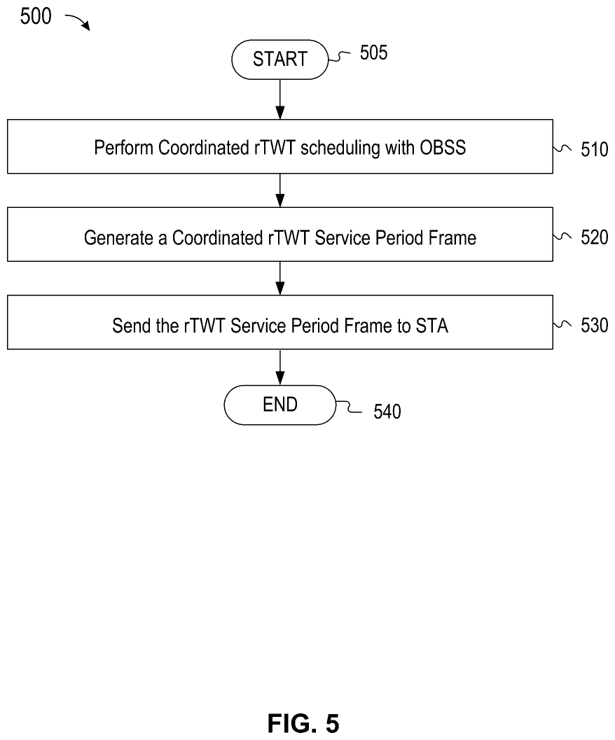

FIG. 5 is a flowchart of a method 500 for coordinated rTWT scheduling. The method 500 begins at starting block 505 and proceeds to operation 510. In operation 510, coordinated rTWT scheduling is performed with an OBSS. For example, the first AP 104 performs coordinated rTWT scheduling with the second AP 112, including determining one or more service periods for the second BSS 110.

In operation 520, a coordinated rTWT service period frame is generated comprising one or more service period elements each associated with one of the one or more a service periods of the OBSS. For example, the first AP 104 generates a coordinated rTWT service period frame 200 comprising one or more service period elements for the service periods of the second BSS 110. The service period elements include a rTWT ID field 204 that identifies an associated service period of the one or more service periods of the second BSS 110 the service period element is associated with and a rTWT requirements field 206 that indicates a communication requirement of the associated service period. The communication requirement can be (i) the service period must be respected, or (ii) the service period must be respected if activity is determined.

In operation 530, the rTWT service period frame is sent to a STA. For example, the first AP 104 sends the coordinated rTWT service period frame 200 to the first BSS STA 106. The first BSS STA 106 is operable to determine whether to communicate during the one or more service periods of the second BSS 110 based on the service period elements.

In certain embodiments, the method 500 can include determining a plurality of quadrants for a Basic Service Set (BSS) comprising one or more stationary STAs in each quadrant of the plurality of quadrants. For example, the first AP 104 determines the north quadrant 410, the east quadrant 412, the south quadrant 414, and the west quadrant 416. Generating the coordinated rTWT service period frame 200 can include determining a communication requirement of the one or more service period elements for each quadrant of the plurality of quadrants. For example, the first AP 104 determines a communication requirement for each of the north quadrant 410, the east quadrant 412, the south quadrant 414, and the west quadrant 416. The first AP 104 can include the communication requirement for each quadrant in the rTWT requirements field 206 for each service period element. The coordinated rTWT service period frame can be sent to the one or more stationary STAs in each quadrant of the plurality of quadrants, wherein the one or more stationary STAs are operable to determine whether to communicate during the one or more service periods of the OBSS based on the communication requirement of the quadrant the one or more stationary STAs are in. For example, the first AP 104 sends the coordinated rTWT service period frame 200 to the stationary STAs 402 so the stationary STAs 402 can determine their respective communication requirement based on the quadrant the stationary STA 402 is in.

The method 500 can further comprise determining a most conservative communication requirement and assigning the most conservative communication requirement to one or more mobile STAs in the BSS. For example, the first AP 104 determines the most conservative communication requirement of the quadrants and assigns the most conservative communication requirement to the mobile STAs 404.

The method 500 can include determining the STA determined to communicate during a service period of the one or more service periods of the OBSS and determining a number of subsequent services periods the STA is enabled to communicate during. For example, the first AP 104 can determine the first BSS STA 106 determined to communicate during a service period and determine zero or more subsequent service periods of the second BSS 110 or, specifically, the service periods assigned to the second BSS STA 114 that the first BSS STA 106 can communicate during. The method 500 can include determining the STA determined not to communicate during a service period of the one or more service periods of the OBSS and determining a number of subsequent services periods the STA is disabled from communicating during. For example, the first AP 104 can determine the first BSS STA 106 determined not to communicate during a service period and determine zero or more subsequent service periods of the second BSS 110 or, specifically, the service periods assigned to the second BSS STA 114 that the first BSS STA 106 will not communicate during. The method 500 may conclude at ending block 540.

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for coordinated rTWT scheduling with respect to FIG. 1, FIG. 2, FIG. 3, FIG. 4, and FIG. 5. Computing device 600, for example, may provide an operating environment for the first AP 104, the first BSS STA 106, the second AP 112, the second BSS STA 114, the stationary STAs 402, the mobile STAs 404, and the like. The first AP 104, the first BSS STA 106, the second AP 112, the second BSS STA 114, the stationary STAs 402, the mobile STAs 404, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

FIG. 7 illustrates an implementation of a communications device 700 that may implement one or more of the first AP 104, the first BSS STA 106, the second AP 112, the second BSS STA 114, the stationary STAs 402, the mobile STAs 404, etc., of FIGS. 1-5. In various implementations, the communications device 700 may comprise a logic circuit. The logic circuit may include physical circuits to perform operations described for one or more of the first AP 104, the first BSS STA 106, the second AP 112, the second BSS STA 114, the stationary STAs 402, the mobile STAs 404, etc., of FIGS. 1-5, for example. As shown in FIG. 7, the communications device 700 may include one or more of, but is not limited to, a radio interface 710, baseband circuitry 730, and/or the computing device 600.

The communications device 700 may implement some or all of the structures and/or operations for the first AP 104, the first BSS STA 106, the second AP 112, the second BSS STA 114, the stationary STAs 402, the mobile STAs 404, etc., of FIGS. 1-5, storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or PHYsical layer (PHY) processing circuit for the PHY link layer processing of respective receive/transmit signals. Baseband circuitry 730 may include, for example, a MAC processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
performing coordinated Restricted Target Wait Time (rTWT) scheduling with an Overlapping Basic Service Set (OBSS), including determining one or more service periods for the OBSS;
generating a coordinated rTWT service period frame comprising one or more service period elements each associated with one of the one or more service periods for the OBSS; and
sending the coordinated rTWT service period frame to a Station (STA), wherein the STA is operable to determine whether to communicate during the one or more service periods of the OBSS based on the one or more service period elements.

2. The method of claim 1, wherein the one or more service period elements each comprise:
a rTWT ID field that identifies an associated service period of the one or more service periods of the OBSS the service period element is associated with; and
a rTWT requirements field that indicates a communication requirement of the associated service period.

3. The method of claim 2, wherein the communication requirement is any one of (i) the associated service period must be respected, or (ii) the associated service period must be respected if activity is determined.

4. The method of claim 1, further comprising:
determining a plurality of quadrants for a Basic Service Set (BSS) comprising one or more stationary STAs in each quadrant of the plurality of quadrants, wherein generating the coordinated rTWT service period frame comprises determining a communication requirement of the one or more service period elements for each quadrant of the plurality of quadrants; and
sending the coordinated rTWT service period frame to the one or more stationary STAs, wherein the one or more stationary STAs are operable to determine whether to communicate during the one or more service periods of the OBSS based on the communication requirement of the quadrant the one or more stationary STAs are in.

5. The method of claim 4, further comprising:
determining a most conservative communication requirement; and
assigning the most conservative communication requirement to one or more mobile STAs in the BSS.

6. The method of claim 1, further comprising:
determining the STA determined to communicate during a service period of the one or more service periods of the OBSS; and
determining a number of subsequent services periods the STA is enabled to communicate during.

7. The method of claim 1, further comprising:
determining the STA determined not to communicate during a service period of the one or more service periods of the OBSS; and
determining a number of subsequent services periods the STA is disabled from communicating during.

8. A system comprising:
a memory storage; and
a processing unit coupled to the memory storage, wherein the processing unit is operative to:
perform coordinated Restricted Target Wait Time (rTWT) scheduling with an Overlapping Basic Service Set (OBSS), including to determine one or more service periods for the OBSS;
generate a coordinated rTWT service period frame comprising one or more service period elements each associated with one of the one or more service periods for the OBSS; and
send the coordinated rTWT service period frame to a Station (STA), wherein the STA is operable to determine whether to communicate during the one or more service periods of the OBSS based on the one or more service period elements.

9. The system of claim 8, wherein the one or more service period elements each comprise:
a rTWT ID field that identifies an associated service period of the one or more service periods of the OBSS the service period element is associated with; and
a rTWT requirements field that indicates a communication requirement of the associated service period.

10. The system of claim 9, wherein the communication requirement is any one of (i) the associated service period must be respected, or (ii) the associated service period must be respected if activity is determined.

11. The system of claim 8, the processing unit being further operative to:
determine a plurality of quadrants for a Basic Service Set (BSS) comprising one or more stationary STAs in each quadrant of the plurality of quadrants, wherein to generate the coordinated rTWT service period frame comprises to determine a communication requirement of the one or more service period elements for each quadrant of the plurality of quadrants; and
send the coordinated rTWT service period frame to the one or more stationary STAs, wherein the one or more stationary STAs are operable to determine whether to communicate during the one or more service periods of the OBSS based on the communication requirement of the quadrant the one or more stationary STAs are in.

12. The system of claim 11, the processing unit being further operative to:
determine a most conservative communication requirement; and
assign the most conservative communication requirement to one or more mobile STAs in the BSS.

13. The system of claim 8, the processing unit being further operative to:
determine the STA determined to communicate during a service period of the one or more service periods of the OBSS; and
determine a number of subsequent services periods the STA is enabled to communicate during.

14. The system of claim 8, the processing unit being further operative to:
determine the STA determined not to communicate during a service period of the one or more service periods of the OBSS; and
determine a number of subsequent services periods the STA is disabled from communicating during.

15. A non-transitory computer-readable medium that stores a set of instructions which when executed perform a method executed by the set of instructions comprising:
performing coordinated Restricted Target Wait Time (rTWT) scheduling with an Overlapping Basic Service Set (OBSS), including determining one or more service periods for the OBSS;
generating a coordinated rTWT service period frame comprising one or more service period elements each associated with one of the one or more service periods of the OBSS; and
sending the coordinated rTWT service period frame to a Station (STA), wherein the STA is operable to determine whether to communicate during the one or more service periods of the OBSS based on the one or more service period elements.

16. The non-transitory computer-readable medium of claim 15, wherein the one or more service period elements each comprise:
a rTWT ID field that identifies an associated service period of the one or more service periods of the OBSS the service period element is associated with; and
a rTWT requirements field that indicates a communication requirement of the associated service period.

17. The non-transitory computer-readable medium of claim 16, wherein the communication requirement is any one of (i) the associated service period must be respected, or (ii) the associated service period must be respected if activity is determined.

18. The non-transitory computer-readable medium of claim 15, the method executed by the set of instructions further comprising:
determining a plurality of quadrants for a Basic Service Set (BSS) comprising one or more stationary STAs in each quadrant of the plurality of quadrants, wherein generating the coordinated rTWT service period frame comprises determining a communication requirement of the one or more service period elements for each quadrant of the plurality of quadrants; and
sending the coordinated rTWT service period frame to the one or more stationary STAs, wherein the one or more stationary STAs are operable to determine whether to communicate during the one or more service periods of the OBSS based on the communication requirement of the quadrant the one or more stationary STAs are in.

19. The non-transitory computer-readable medium of claim 15, the method executed by the set of instructions further comprising:
determining the STA determined to communicate during a service period of the one or more service periods of the OBSS; and
determining a number of subsequent services periods the STA is enabled to communicate during.

20. The non-transitory computer-readable medium of claim 15, the method executed by the set of instructions further comprising:
determining the STA determined not to communicate during a service period of the one or more service periods of the OBSS; and
determining a number of subsequent services periods the STA is disabled from communicating during.
